(19) United States
(12) Patent Application Publication
(10) Pub. No.: US 2017/0177149 A1
(43) Pub. Date: Jun. 22, 2017

(54) TOUCH CONTROL BUTTON, TOUCH CONTROL PANEL, AND TOUCH CONTROL TERMINAL

(71) Applicant: Xiaomi Inc., Beijing (CN)

(72) Inventors: Gang WANG, Beijing (CN); Zhongsheng JIANG, Beijing (CN); Shaoxing HU, Beijing (CN)

(73) Assignee: Xiaomi Inc.

(21) Appl. No.: 15/379,606

(22) Filed: Dec. 15, 2016

(30) Foreign Application Priority Data
Dec. 16, 2015 (CN) 201510946737.7

(51) Int. Cl. G06F 3/041; G06F 3/044

(52) U.S. Cl. CPC G06F 3/0416; G06F 3/044; G06F 2203/04107; G06F 2203/04105

(57) ABSTRACT

A touch control button includes a touch sensing layer, a pressure sensing layer, and a shielding layer. The pressure sensing layer is disposed below the touch sensing layer in a touch control button area of the touch control button. The shielding layer is disposed below the pressure sensing layer and at a preset distance from the pressure sensing layer.

### CROSS REFERENCE TO RELATED APPLICATION

This application is based on and claims priority to Chinese Patent Application No. 201510946737.7, filed on Dec. 16, 2015, the entire contents of which are incorporated herein by reference.

### TECHNICAL FIELD

The present disclosure relates to a computer technology field, and more particularly to a touch control button, a touch control panel, and a touch control terminal.

### BACKGROUND

In a pressure-sensitive control technology, a pressing strength is sensed by a pressure-sensitive control device. Touch control actions on a touch control panel, such as clicking, slight pressing, and heavy pressing, can be realized in response to sensing results.

In the related art, the pressure-sensitive control technology is generally used in a viewing area of a touch control panel. However, the touch control at a touch control button out of the viewing area is generally realized through a self-capacitive or mutual-capacitive sensing technology independent of the viewing area, while the pressure sensitive touch control cannot be realized at the touch control button.

### SUMMARY

According to a first aspect of the present disclosure, there is provided a touch control button including a touch sensing layer, a pressure sensing layer, and a shielding layer. The pressure sensing layer is disposed below the touch sensing layer in a touch control button area of the touch control button. The shielding layer is disposed below the pressure sensing layer and at a preset distance from the pressure sensing layer.

According to another aspect of the present disclosure, there is provided a touch control panel including a viewing area and a touch control button area. The touch control button area is disposed in an area out of the viewing area and includes one or more touch control buttons. The viewing area includes a display screen, a touch sensing layer on the display screen, and a protective layer on the touch sensing layer. The touch control button area includes the protective layer, the touch sensing layer, a pressure sensing layer, and a shielding layer. The pressure sensing layer is disposed below the touch sensing layer in the touch control button area. The shielding layer is disposed below the pressure sensing layer and at a preset distance from the pressure sensing layer.

According to another aspect of the present disclosure, there is provided a touch control terminal including a processor and a touch control panel. The touch control panel comprises a viewing area and a touch control button area outside of the viewing area. The viewing area includes a display screen, a touch sensing layer on the display screen, and a protective layer on the touch sensing layer. The touch control button area includes the protective layer, the touch sensing layer, a pressure sensing layer, and a shielding layer. The pressure sensing layer is disposed below the touch sensing layer in the touch control button area and the shielding layer is disposed below the pressure sensing layer and at a preset distance from the pressure sensing layer. The processor is configured to: detect a touch control signal on the display screen, and perform a first operation according to the touch control signal; and detect a touch pressing signal at the touch control button area, and perform a second operation according to the touch pressing signal.

It is to be understood that both the foregoing general description and the following detailed description are exemplary and explanatory only and are not restrictive of the disclosure.

### BRIEF DESCRIPTION OF THE DRAWINGS

Accompanying drawings herein are incorporated in and constitute a part of the specification, and illustrate example embodiments in line with the present disclosure, and serve to explain the principle of the present disclosure together with the description.

FIG. 1 is a schematic diagram of a touch control terminal provided with a touch control button in the related art.

FIG. 2 is a cross-sectional view of a touch control terminal according to an example embodiment.

FIG. 3 is a cross-sectional view of another touch control terminal according to an example embodiment.

FIG. 4 is a cross-sectional view of another touch control terminal according to an example embodiment.

FIG. 5 is a schematic diagram illustrating components of a touch control terminal according to an example embodiment.

FIG. 6 is a block diagram of a touch control terminal according to an example embodiment.

Embodiments of the present disclosure are illustrated in the above accompany drawings and will be described in further detail hereinafter. These accompany drawings and literal description are not intended to limit the scope of the idea of the present disclosure, but to explain the principle of the present disclosure with reference to particular embodiments for those skilled in the art.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the disclosure. Instead, they are merely examples of apparatuses and methods consistent with aspects related to the disclosure as recited in the appended claims.

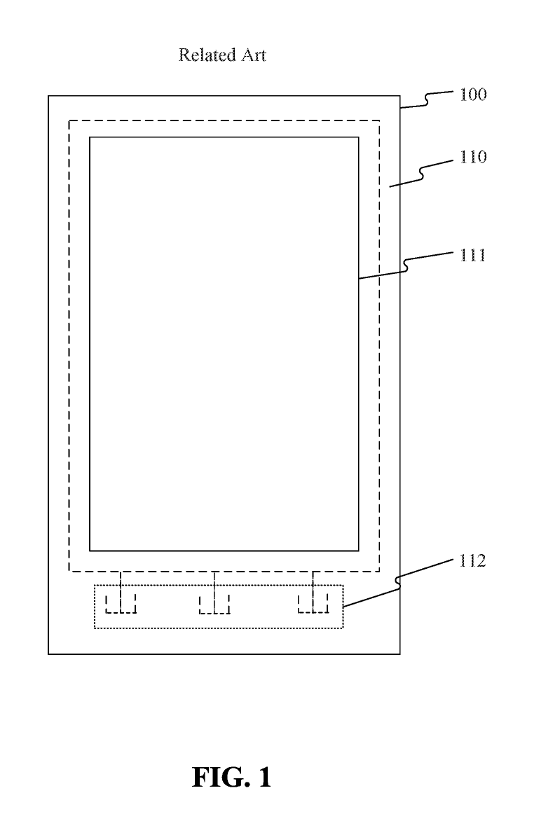

FIG. 1 is a schematic diagram of a touch control terminal 100 provided with one or more touch control buttons in the related art. As shown in FIG. 1, the touch control terminal 100 includes a touch control panel 110 which includes a viewing area (VA) 111 and a touch control button area 112 outside of the viewing area 111. The touch control at area 112 is realized via a self-capacitive or mutual capacitive technology.

FIG. 2 shows a cross-sectional view of an exemplary touch control terminal 200 according to an embodiment of the present disclosure. A bird's eye view of the touch control terminal 200 looks similar to touch control terminal 100 shown in FIG. 1 and thus is not illustrated separately. As shown in FIG. 2, the touch control terminal 200 includes a touch sensing layer 210, a pressure sensing layer 220, a shielding layer 230, a protective layer 240, and a body 250. The touch control terminal 200 has a touch control button area 202, which includes one or more touch control buttons.

The touch sensing layer 210 is disposed under the protective layer 240 and configured to sense a touch operation, such as clicking, double-clicking, long-pressing, etc. performed on the touch control button area 202 by a touch subject.

The pressure sensing layer 220 is disposed under the touch sensing layer 210 in the touch control button area 202. The pressure sensing layer 220 may be directly attached to a bottom surface of the touch sensing layer 210 via a conductive adhesive 260.

The shielding layer 230 is disposed under the pressure sensing layer 220 and at a preset distance from the pressure sensing layer 220. Further, the shielding layer 230 is grounded. The pressure sensing layer 220 is configured to sense a pressing operation on the touch control button area 202 by the touch subject. For example, different operations correspond to different pressures on the touch control button area 202.

In one embodiment, as shown in FIG. 2, the shielding layer 230 is attached to the body 250 of the touch control terminal 200 right directly under the pressure sensing layer 220.

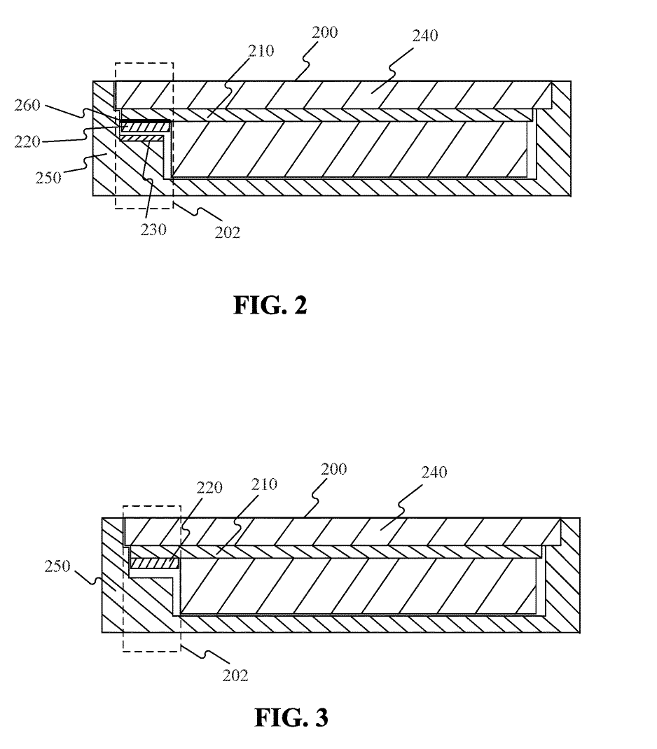

In another example embodiment of the present disclosure, if the body 250 of the touch control terminal 200 is made of metal, as shown in FIG. 3, the metal body 250 can be configured as a shielding layer, such that the shielding layer 230 may be omitted.

Each of the pressure sensing layer 220 and the shielding layer 230 may include any one selected from indium tin oxide (ITO), flexible printed circuit board (FPC), and a metal film (such as silver) printed on polyethylene terephthalate (PET) base material. Each one of the above materials is easy to acquire and of a low cost, such that the overall cost of the touch control button area 202 is low.

In the illustrated embodiment, a capacitance is formed between the pressure sensing layer 220 and the shielding layer 230. When a finger presses the touch control button area 202, a distance between the pressure sensing layer 220 and the shielding layer 230 becomes smaller, such that the electric signal sensed by the pressure sensing layer 220 changes after the press. The pressure pressing the touch control button area 202 can be determined according to the change of electric signal.

The protective layer 240 is disposed above the touch sensing layer 210, and configured to protect respective sensing layers below the protective layer 240. The protective layer 240 may be reinforced glass.

The touch control button area according to the disclosed embodiments include the touch sensing layer, the pressure sensing layer, and the shielding layer. The pressure sensing layer is disposed under the touch sensing layer, and the shielding layer is disposed under the pressure sensing layer. When a finger or a touch subject presses on the touch control button area, the gap between the pressure sensing layer and the shielding layer becomes smaller, such that the electric signal sensed by the pressure sensing layer changes. The pressure of the finger or the touch subject applied on the touch control button area may be determined according to the change of the electric signal. Since the touch control button(s) may be realized by sensing the pressure(s) applied thereon, the touch control terminal provided with such touch control buttons may respond to the pressure-sensitive touch control operation. In this way, in addition to sensing a duration of time the pressure is applied on the touch control buttons, the human-machine interaction based on the touch control buttons may also include sensing the pressures, thereby enriching levels and improving user experience of the human-machine interaction.

Corresponding to the above touch control button(s), the present disclosure further provides embodiments of a touch control panel provided with the touch control button(s).

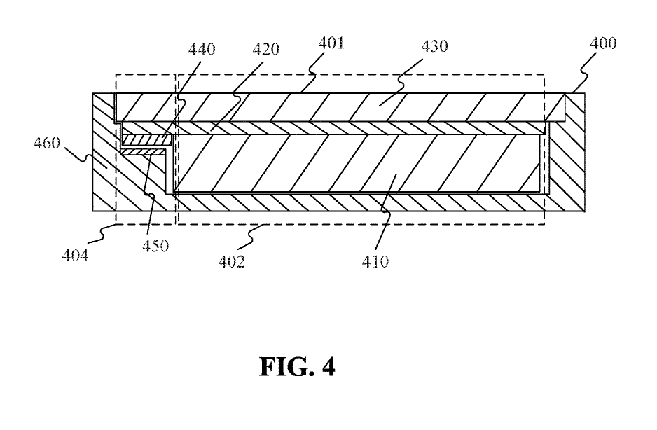

FIG. 4 is a cross-sectional view of a touch control terminal 400 according to an example embodiment. As shown in FIG. 4, the touch control terminal 400 includes a touch sensing panel 401 which includes a viewing area 402 and a touch control button area 404.

The viewing area 402 includes a display screen 410, a touch sensing layer 420, and a protective layer 430. In addition to the protective layer 430 and the touch sensing layer 420, the touch control button area 404 also includes a pressure sensing layer 440 and a shielding layer 450. In the illustrated embodiment, both the protective layer 430 and the touch sensing layer 420 cover the viewing area 402 and the touch control button area 404.

In the viewing area 402, the display screen 410 is disposed adjacent to an end of a body 460 of the touch control panel 400. The touch sensing layer 420 is disposed above the display screen 410. The protective layer 430 is disposed above the touch sensing layer 420.

In the touch control button area 404, the pressure sensing layer 440 is disposed below the touch sensing layer 420. The shielding layer 450 is disposed below the pressure sensing layer 440 such that a gap is formed therebetween. The shielding layer 450 is grounded.

In an example embodiment of the present disclosure, the shielding layer 450 is attached to body 460 of the touch control terminal 400 disposed directly below the pressure sensing layer 440.

In another example embodiment of the present disclosure, if the body 460 of the touch control terminal 400, which carries the touch control panel 401, is made of metal, the metal body 460 may be configured as the shielding layer, so that the shielding layer 450 may be omitted.

In this embodiment, each of the pressure sensing layer 440 and the shielding layer 450 may include any one of ITO, FPC or a metal film (such as, silver) printed on PET.

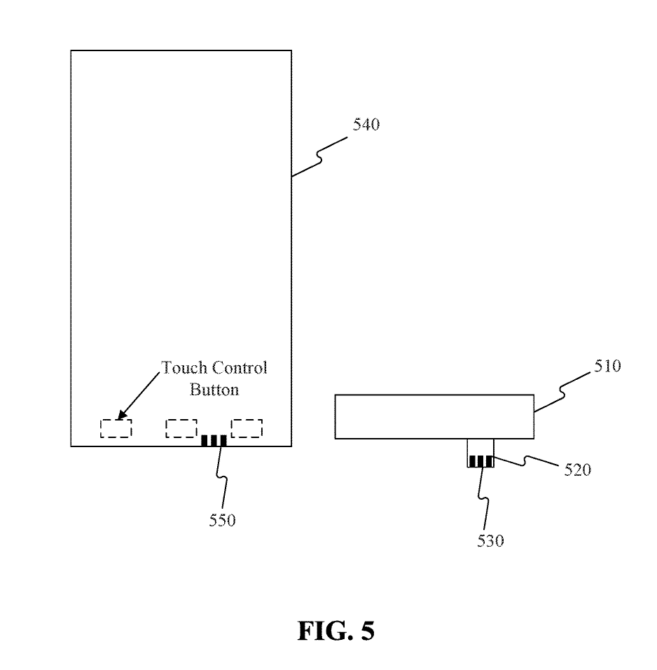

FIG. 5 is a schematic diagram illustrating components of a touch control terminal according to an example embodiment. As shown in FIG. 5, a flexible conductive board 520 is disposed at an edge of a pressure sensing layer 510. The flexible conductive board 520 is provided with a first bonding pad 530. A touch sensing layer 540 is provided with a second bonding pad 550 at a position corresponding to the first bonding pad 530. Further, the second bonding pad 550 is connected to a touch control chip (not shown) via wires (not shown) on the touch sensing layer 540.

After the pressure sensing layer 510 is attached to a bottom surface of the touch sensing layer 540, the first bonding pad 530 is electrically connected to the second bonding pad 550, such that the wires of the pressure sensing layer 510 are connected to the touch control chip via the wires of the touch sensing layer 540, such that the touch control chip can detect pressure sensitive touch control operations and touch operations.

The touch control panel according to this embodiment includes the viewing area and the touch control button area outside of the viewing area. The touch control button area includes the touch sensing layer, the pressure sensing layer, and the shielding layer. The pressure sensing layer is disposed below the touch sensing layer, and the shielding layer is disposed below the pressure sensing layer. When a finger or a touch subject presses on the touch control button area, the gap between the pressure sensing layer and the shielding layer becomes smaller, such that the electric signal sensed by the pressure sensing layer changes. The pressure of the finger or the touch subject applied on the touch control button area may be determined according to the change of the electric signal. Since the touch control button(s) may be used to sense the pressure(s) applied thereon, the touch control terminal provided with such touch control buttons may respond to the pressure-sensitive touch control operation. In this way, in addition to sensing a duration of time the pressure is applied on the touch control buttons, the human-machine interaction based on the touch control buttons may also include sensing the pressures, thereby enriching levels and improving user experience of the human-machine interaction.

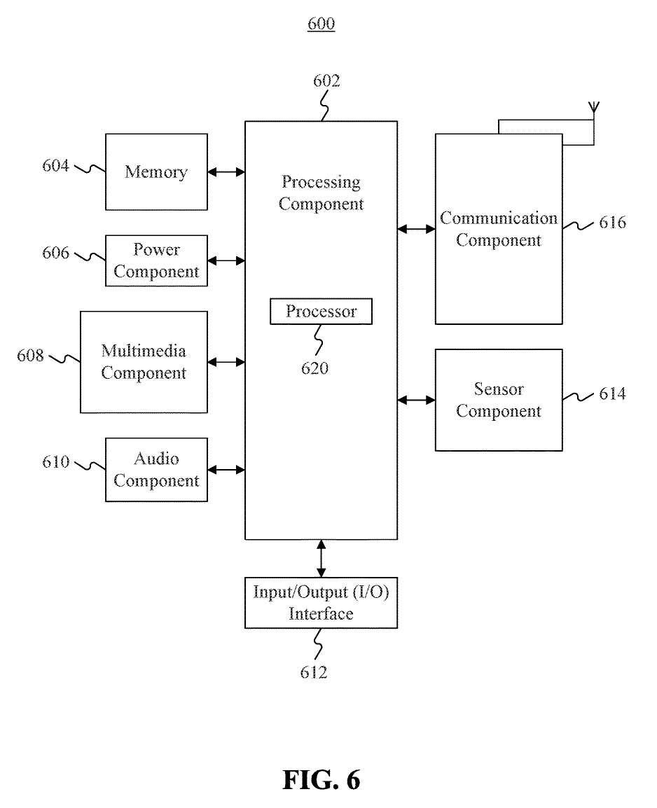

FIG. 6 is a block diagram of a touch control terminal 600 according to an embodiment of the present disclosure. For example, the touch control terminal 600 may be a mobile phone, a computer, a digital broadcast terminal, a message transceiver, a game console, a tablet device, a medical equipment, a fitness equipment or a personal digital assistance etc.

Referring to FIG. 6, the touch control terminal 600 may include one or more of the following components: a processing component 602, a memory 604, a power component 606, a multimedia component 608, an audio component 610, an input/output (I/O) interface 612, a sensor component 614, and a communication component 616.

The processing component 602 typically controls overall operations of the touch control terminal 600, such as the operations associated with display, telephone calls, data communications, camera operations, and recording operations. The processing component 602 may include one or more processors 620 to execute instructions to perform all or part of the steps in the above described operations. Moreover, the processing component 602 may include one or more modules which facilitate the interaction between the processing component 602 and other components. For instance, the processing component 602 may include a multimedia module to facilitate the interaction between the multimedia component 608 and the processing component 602.

The memory 604 is configured to store various types of data to support the operations of the touch control terminal 600. Examples of such data include instructions for any applications or methods operated on the touch control terminal 600, contact data, phonebook data, messages, pictures, video, etc. The memory 604 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 606 provides power to various components of the touch control terminal 600. The power component 606 may include a power management system, one or more power sources, and any other components associated with the generation, management, and distribution of power in the touch control terminal 600.

The multimedia component 608 includes a screen providing an output interface between the touch control terminal 600 and the user. In some embodiments, the screen may include a liquid crystal display and a touch panel. If the screen includes the touch control panel, the screen may be implemented as a touch screen to receive input signals from the user. The touch control panel includes one or more touch sensors to sense touches, swipes, and gestures on the touch control panel. The touch sensors may not only sense a boundary of a touch or swipe action, but also sense a period of time and a pressure associated with the touch or swipe action.

In some embodiments, the touch control panel further includes a touch control button area having one or more touch control buttons. The touch control button area includes a protective layer, a touch sensing layer, a pressure sensing layer and a shielding layer. The pressure sensing layer is disposed below the touch sensing layer, and the shielding layer is disposed below the pressure sensing layer and at a preset distance from the pressure sensing layer. A capacitance is formed between the pressure sensing layer and the shielding layer. When a finger presses the touch control button area, the distance between the pressure sensing layer and the shielding layer becomes smaller, such that the electric signal sensed by the pressure sensing layer changes. The pressure of pressing the touch control button area may be determined according to the change of the electric signal. Further, the processing component 602 may perform different operations according to different pressures applied on the touch control button(s).

In some embodiments, the multimedia component 608 includes a front camera and/or a rear camera. The front camera and the rear camera may receive an external multimedia datum while the touch control terminal 600 is in an operation mode, such as a photographing mode or a video mode. Each of the front camera and the rear camera may be a fixed optical lens system or have focus and optical zoom capability.

The audio component 610 is configured to output and/or input audio signals. For example, the audio component 610 includes a microphone configured to receive an external audio signal when the touch control terminal 600 is in an operation mode, such as a call mode, a recording mode, and a voice recognition mode. The received audio signal may be further stored in the memory 604 or transmitted via the communication component 616. In some embodiments, the audio component 610 further includes a speaker to output audio signals.

The I/O interface 612 provides an interface between the processing component 602 and peripheral interface modules, such as a keyboard, a click wheel, buttons, and the like. The buttons may include, but are not limited to, a home button, a volume button, a starting button, and a locking button.

The sensor component 614 includes one or more sensors to provide status assessments of various aspects of the touch control terminal 600. For instance, the sensor component 614 may detect an open/closed status of the touch control terminal 600, relative positioning of components, e.g., the display and the keypad, of the touch control terminal 600, a change in position of the touch control terminal 600 or a component of the touch control terminal 600, a presence or absence of user contact with the touch control terminal 600, an orientation or an acceleration/deceleration of the touch control terminal 600, and a change in temperature of the touch control terminal 600. The sensor component 614 may include a proximity sensor configured to detect the presence of nearby objects without any physical contact. The sensor component 614 may also include a light sensor, such as a CMOS or CCD image sensor, for use in imaging applications. In some embodiments, the sensor component 614 may also include an accelerometer sensor, a gyroscope sensor, a magnetic sensor, a pressure sensor, or a temperature sensor.

The communication component 616 is configured to facilitate communication, wired or wirelessly, between the touch control terminal 600 and other devices. The touch control terminal 600 can access a wireless network based on a communication standard, such as WiFi, 2G, 3G, or 4G, or a combination thereof. In one exemplary embodiment, the communication component 616 receives a broadcast signal or broadcast associated information from an external broadcast management system via a broadcast channel. In one exemplary embodiment, the communication component 616 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the touch control terminal 600 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer-readable storage medium including instructions, such as included in the memory 604, executable by the processor 620 in the touch control terminal 600, for performing the above-described operations. For example, the non-transitory computer-readable storage medium may be a ROM, a RAM, a CD-ROM, a magnetic tape, a floppy disc, an optical data storage device, and the like.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A touch control button comprising a touch sensing layer, a pressure sensing layer, and a shielding layer, wherein:
the pressure sensing layer is disposed below the touch sensing layer in a touch control button area of the touch control button; and
the shielding layer is disposed below the pressure sensing layer and at a preset distance from the pressure sensing layer.

2. The touch control button according to claim 1, wherein:
the shielding layer is disposed on a body of a terminal below the pressure sensing layer, wherein the terminal is provided with the touch control button; or
the shielding layer is a metal body of a terminal provided with the touch control button.

3. The touch control button according to claim 1, wherein the pressure sensing layer is attached to a bottom surface of the touch sensing layer in the touch control button area via a conductive adhesive.

4. The touch control button according to claim 1, wherein each of the pressure sensing layer and the shielding layer includes tin indium oxide, flexible circuit board, or a metal film printed on a polyethylene glycol terephthalate material.

5. The touch control button according to claim 1, further including a flexible conductive board disposed at an edge of the pressure sensing layer, wherein:
the flexible conductive board is provided with a first bonding pad; and
the touch sensing layer is provided with a second bonding pad electrically connected to a touch control chip and disposed at a position corresponding to the first bonding pad.

6. A touch control panel, comprising a viewing area and a touch control button area, wherein:
the touch control button area is disposed in an area out of the viewing area and includes one or more touch control buttons;
the viewing area includes a display screen, a touch sensing layer on the display screen, and a protective layer on the touch sensing layer;
the touch control button area includes the protective layer, the touch sensing layer, a pressure sensing layer, and a shielding layer;
the pressure sensing layer is disposed below the touch sensing layer in the touch control button area; and
the shielding layer is disposed below the pressure sensing layer and at a preset distance from the pressure sensing layer.

7. The touch control panel according to claim 6, wherein,
the shielding layer is disposed on a body of a terminal below the pressure sensing layer, wherein the terminal is provided with the touch control panel; or
the shielding layer is a metal body of a terminal provided with the touch control panel.

8. The touch control panel according to claim 6, wherein the pressure sensing layer is attached to a bottom surface of the touch sensing layer in the touch control button area via a conductive adhesive.

9. The touch control panel according to claim 6, wherein each of the pressure sensing layer and the shielding layer includes tin indium oxide, flexible circuit board, or a metal film printed on a polyethylene glycol terephthalate material.

10. The touch control panel according to claim 6, further including a flexible conductive board disposed at an edge of the pressure sensing layer, wherein:
the flexible conductive board is provided with a first bonding pad; and
the touch sensing layer is provided with a second bonding pad electrically connected to a touch control chip and disposed at a position corresponding to the first bonding pad.

11. A touch control terminal, comprising a processor and a touch control panel, wherein:
the touch control panel comprises a viewing area and a touch control button area outside of the viewing area;
the viewing area includes a display screen, a touch sensing layer on the display screen, and a protective layer on the touch sensing layer;
the touch control button area comprises the protective layer, the touch sensing layer, a pressure sensing layer, and a shielding layer, the pressure sensing layer being disposed below the touch sensing layer in the touch control button area and the shielding layer being disposed below the pressure sensing layer and at a preset distance from the pressure sensing layer; and
the processor is configured to:
detect a touch control signal on the display screen, and perform a first operation according to the touch control signal; and
detect a touch pressing signal at the touch control button area, and perform a second operation according to the touch pressing signal.
